(19) United States
(12) Patent Application Publication
(10) Pub. No.: US 2005/0268315 A1
(43) Pub. Date: Dec. 1, 2005

(54) Disc cartridge

(76) Inventors: Yoshito Saji, Hyogo (JP); Teruyuki Takizawa, Osaka (JP); Tetsuya Kaneshiro, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/519,735

(22) PCT Filed: Jul. 23, 2003
(86) PCT No.: PCT/JP03/09359

§ 371 Date: Dec. 28, 2004

(30) Foreign Application Priority Data
Jul. 30, 2002 (JP) 2002-221000

(51) Int. Cl. G11B 23/03

(52) U.S. Cl. 720/725

(57) ABSTRACT

A disc cartridge stores a disc that has a first side with a first functional portion and a second side. The disc cartridge includes: a cartridge body including a disc storage portion, a chucking opening and a head opening, where the disc storage portion has a disc window and a bottom and stores the disc therein so that the first side thereof is exposed through the disc window; the chucking opening is provided on the bottom of the disc storage portion so as to get the disc chucked externally; and the head opening is also provided on the bottom of the disc storage portion so as to allow a head, which reads and/or writes data from/on the second side of the disc, to access the second side; a shutter, supported to, and movable with respect to, the cartridge body so as to expose or cover at least the head opening; and a second functional portion, which is provided for the cartridge body and which produces an audiovisual effect by cooperating with the first functional portion of the disc.

### TECHNICAL FIELD

The present invention relates to a disk such as an optical disc or a magnetic disk and a disc cartridge to store the disk therein. The present invention also relates to a disc drive for reading and writing data from/on the disk.

### BACKGROUND ART

Recently, as information technologies have been developed remarkably, the storage densities of various types of disk-shaped data storage media, including optical discs and magnetic disks, have been increased significantly. Meanwhile, a broader and broader variety of data can now be stored on such a data storage medium. Thus, not just computer data and software but also music, video and numerous other types of data are now storable on such storage media.

Such a data storage medium is normally provided as a circular disc with a data recording side and a label side. Examples of such discs include CDs and DVDs. On the other hand, another type of data storage medium, including a circular disc with single or double data recording sides and a disc cartridge that covers the disc entirely to store it, is also used extensively. Examples of such data storage media include MDs, DVD-RAMs and MOs.

The data stored on each of these data storage media is not perceivable to human beings in themselves. Thus, in conventional data storage media, information representing the data (or contents) stored thereon is provided as printing on the label side of a disc or on a predetermined area of a disc cartridge. For example, as for a data storage medium on which music or movie data is stored, the titles of the musical tunes or that of the movie is typically shown there. If the given data storage medium allows the user to write data thereon, then the user notes down some information describing the contents of the stored data either on the label side or on the predetermined area of its disc cartridge.

If such a data storage medium with some data stored thereon needs to be sold as a product, then that information printed on the label side of the disc or on the disc cartridge plays a key role in making the product attractive enough for buyers. This is because the buyers cannot see what type of data is contained there just by looking at the data storage medium itself.

In the conventional data storage media, however, that area on which information describing the contents is printed has limited sizes, and methods of providing such information on that area are limited, too. For example, the printable area on the label side of the disc or on the disc cartridge has a predetermined shape. Accordingly, no novel or highly visualized printing is allowed to be provided on that area for designers. Also, in a CD, for example, a data storage layer is located at a depth of 0.1 mm as measured from the surface of the label side. Thus, the designer is never allowed to provide any 3D printing or etching having some level differences on the label side.

Furthermore, as for a data storage medium in which a disc is stored in a disc cartridge, once the disc that has been stored in the disc cartridge is exchanged for another one, the information printed on the disc cartridge might be different from the data actually stored on the disc. In that case, the information that is printed or described on the disc cartridge would become meaningless.

### DISCLOSURE OF INVENTION

In order to overcome the problems described above, an object of the present invention is to provide a disc and a disc cartridge that can achieve novel audiovisual effects in presenting information about the contents stored thereon. Another object of the present invention is to provide a disc drive for such a disc or disc cartridge.

A disc cartridge according to the present invention stores a disc that has a first side with a first functional portion and a second side. The disc cartridge includes a cartridge body, a shutter and a second functional portion. The cartridge body includes a disc storage portion, a chucking opening and a head opening. The disc storage portion has a disc window and a bottom and stores the disc therein so that the first side thereof is exposed through the disc window. The chucking opening is provided on the bottom of the disc storage portion so as to get the disc chucked externally. The head opening is also provided on the bottom of the disc storage portion so as to allow a head, which reads and/or writes data from/on the second side of the disc, to access the second side of the disc. The shutter is supported to, and movable with respect to, the cartridge body so as to expose or cover at least the head opening. The second functional portion is provided for the cartridge body and produces an audiovisual effect by cooperating with the first functional portion of the disc.

In one preferred embodiment, the first and second functional portions produce a visual effect by cooperating with each other.

In another preferred embodiment, the first and second functional portions produce an audio effect by cooperating with each other.

In another preferred embodiment, audiovisual information is stored on the second side of the disc, and the audiovisual effect is associated with the audiovisual information on the second side of the disc.

In another preferred embodiment, the first functional portion is a first design provided on the first side, the second functional portion is a second design provided on a portion of the upper surface of the cartridge body near the disc window, and the first and second designs are combined together to make up a third design that looks like a single continuous design.

In another preferred embodiment, the first design is a picture drawn on the first side and the second design is a picture drawn on the upper surface.

In another preferred embodiment, the first and second designs are planar.

In another preferred embodiment, the first and second designs are embossed.

In another preferred embodiment, the depth of the first embossed design is substantially equal to that of the second embossed design.

In another preferred embodiment, the first side of the disc and the upper surface of the cartridge body are textured.

In another preferred embodiment, the first and second designs are holograms.

In another preferred embodiment, the first functional portion is a tablet that is provided on the first side to allow the user to draw or erase any traces thereon or therefrom, and the second functional portion is an erasing portion that is provided for the cartridge body and is used for erasing the traces that have been drawn on the tablet.

In another preferred embodiment, the tablet includes a magnetic body so as to allow the user to draw the traces by bringing a magnet or another magnetic body close to the surface of the tablet.

In another preferred embodiment, the tablet includes a plurality of small rooms, each being filled with a viscous fluid and a magnetic powder.

In another preferred embodiment, the erasing portion is a magnet plate that is provided on the bottom of the disc storage portion of the cartridge body.

In another preferred embodiment, the traces that have been drawn on the tablet are erased by rotating the disc within the disc storage portion of the cartridge body.

In another preferred embodiment, the first functional portion is a matrix-addressed display device that is provided on the first side and that includes a liquid crystal, organic EL or inorganic EL material, while the second functional portion is provided for the cartridge body and includes a control section for driving the matrix-addressed display device, a memory for storing image data to be presented on the matrix-addressed display device, and a power supply for supplying power to the matrix-addressed display device.

In another preferred embodiment, the second functional portion further includes a loudspeaker provided for the cartridge body.

In another preferred embodiment, the first functional portion further includes a transparent tablet on the surface of the matrix-addressed display device such that information fed into the tablet is displayed on the matrix-addressed display device.

In another preferred embodiment, the first functional portion is a planar loudspeaker that is provided on the first side, while the second functional portion includes a memory for storing audio information to be reproduced through the planar loudspeaker, a control section for converting the audio information and transmitting a signal to the planar loudspeaker, and a power supply for supplying power to the control section.

In another preferred embodiment, the second functional portion further includes a microphone that is provided for the cartridge body, and the control section converts sound, recorded with the microphone, into the audio information and then stores the information in the memory.

In another preferred embodiment, the disc includes a disc-side terminal, which is connected to the first functional portion and which is provided on the outer periphery of the disc, and the cartridge body includes a body-side terminal which is connected to the second functional portion.

In another preferred embodiment, the disc cartridge further includes a disc holding portion for holding the disc thereon while the shutter is closed, and the disc-side and body-side terminals are contactable with each other while the disc is being held by the disc holding portion.

In another preferred embodiment, the disc-side terminal is a plurality of concentric ringlike conductive regions provided along the outer periphery of the disc.

In another preferred embodiment, the disc has a disc-side mark, the cartridge body has a body-side mark, and when the disc is rotated within the disc storage portion of the cartridge body such that the disc-side and body-side marks are aligned with each other, the disc-side and body-side terminals contact with each other.

In another preferred embodiment, the disc includes a disc-side terminal, which is connected to the first functional portion, provided on the first side and has a conductive surface, while the cartridge body includes a body-side terminal, which is connected to the second functional portion, provided on the upper surface of the cartridge body and has a conductive surface. When the disc-side and body-side terminals are touched with fingers at the same time, the first and second functional portions are electrically connected together.

A disc drive according to the present invention includes: a supporting portion into which the disc cartridge of one of claims 1 to 16 is loadable, a disc having a first side with a first functional portion and a second side being stored in the disc cartridge; a spindle motor for mounting and rotating the disc thereon; a head, which is able to read and/or write data from/on the second side of the disc; a sensor for detecting a rotational angular position of the spindle motor when the disc is mounted on the spindle motor; and a control section for controlling the spindle motor in accordance with a command to eject the disc cartridge such that the spindle motor stops at the rotational angular position when the disc is mounted thereon.

Another disc drive according to the present invention includes: a supporting portion into which the disc cartridge of one of claims 1 to 16 is loadable, a disc having a first side with a first functional portion and a second side being stored in the disc cartridge; a spindle motor for mounting and rotating the disc thereon; a head, which is able to read and/or write data from/on the second side of the disc; a sensor for detecting a mark on the second side of the disc; and a control section for controlling the spindle motor such that the spindle motor stops at a position where the mark of the disc is detected.

A disc according to the present invention includes a data storage layer, a first substrate, and a second substrate. The data storage layer is sandwiched between the first and second substrates. Data is read or written from/on the data storage layer through the second substrate. The first substrate has a thickness of 0.5 mm or more.

In one preferred embodiment, the surface of the first substrate is provided with an embossed design including concave and convex portions.

In another preferred embodiment, the first substrate includes a first layer, of which the surface is provided with the embossed design including the concave and convex portions, and a second layer, which is transparent and covers the surface of the first layer.

In another preferred embodiment, the design is related to the data stored on the data storage layer.

In another preferred embodiment, the concave and convex portions of the design have level differences of 0.2 mm to 1.0 mm.

In another preferred embodiment, the first substrate includes a first layer to support the data storage layer thereon and a second layer, which is provided as a film on the surface of the first layer. A scratch mark can be easily left on, or erased from, the second layer with a coin or a fingernail.

In another preferred embodiment, the second layer is provided in multiple areas on the surface of the first layer. By leaving a scratch mark on a particular portion of the second layer in the process step of testing the disc, property information about its warpage, eccentricity or center of mass is displayed.

In another preferred embodiment, predetermined information is printed on the surface of the first layer and is disclosed by scratching the second layer off.

In another preferred embodiment, the information is a quiz answer, a lottery winning mark or foretold future.

### BRIEF DESCRIPTION OF DRAWINGS

FIG. 1 is a perspective view illustrating an overall configuration for a disc cartridge for use in the present invention.

FIG. 2 is an exploded perspective view illustrating an exploded state of the disc cartridge shown in FIG. 1.

FIG. 3 is a perspective view illustrating a state of the disc cartridge shown in FIG. 1 in which its shutters are closed with its cartridge upper shell and the disc removed.

FIG. 4 is a perspective view illustrating a state of the disc cartridge shown in FIG. 1 in which its shutters are opened with its cartridge upper shell and the disc removed.

FIG. 5 is a perspective view illustrating a state of the disc cartridge shown in FIG. 1 in which its shutters are closed with the disc removed.

FIG. 6 is a perspective view illustrating a state of the disc cartridge shown in FIG. 1 in which its shutters are opened with the disc removed.

FIG. 7 is a partial cross-sectional view illustrating a cross section of the disc cartridge shown in FIG. 1 that passes the center of the disc.

FIG. 8 is a cross-sectional view illustrating a portion of the shutter of the disc cartridge shown in FIG. 1.

FIG. 9 is a partial plan view illustrating an operating portion and its surrounding portion of the disc cartridge shown in FIG. 1.

FIG. 10 is a perspective view illustrating a stopper member of the disc cartridge shown in FIG. 1.

FIG. 11 is a perspective view illustrating a data storage medium according to a first embodiment of the present invention.

FIG. 12 is a cross-sectional view of the data storage medium shown in FIG. 1 as taken in the thickness direction thereof.

FIGS. 13A and 13B schematically illustrate the size of the label plane of a conventional disc and the size of a rectangular displayable area of a data storage medium according to the present invention, respectively.

FIG. 14 schematically shows a configuration for a disc drive for use in the data storage medium shown in FIG. 11.

FIG. 15 schematically shows a configuration for another disc drive for use in the data storage medium shown in FIG. 11.

FIG. 16 is a perspective view illustrating a data storage medium according to a second embodiment of the present invention.

FIG. 17 is a cross-sectional view of the data storage medium shown in FIG. 16 as taken in the thickness direction thereof.

FIG. 18 is a perspective view illustrating a data storage medium according to a third embodiment of the present invention.

FIG. 19 is a perspective view illustrating a data storage medium according to a fourth embodiment of the present invention.

FIG. 20 is a perspective view illustrating a data storage medium according to a modified example of the third embodiment of the present invention.

FIG. 21 is a cross-sectional view illustrating a data storage medium according to a fourth embodiment of the present invention.

FIG. 22 is a perspective view illustrating an overall configuration for another disc cartridge that can be used in the present invention.

### BEST MODE FOR CARRYING OUT THE INVENTION

First, the common structural features of disc cartridges according to the present invention will be described. The disc cartridge disclosed in PCT International Application Publication No. WO 02/056313 and its corresponding U.S. patent application Ser. No. 10/289,963 or the disc cartridge disclosed in PCT International Application Publication No. WO 03/041076 and its corresponding U.S. patent application Ser. No. ______ (which was filed on Jun. 17, 2003 by an attorney with a docket number 210407.0052/052 US) may be used in any preferred embodiment of the present invention. Thus, the disclosure of PCT International Application Publication No. WO 02/056313, U.S. patent application Ser. No. 10/289,963, PCT International Application Publication No. WO 03/041076 and U.S. patent application Ser. No. ______ (which was filed on Jun. 17, 2003 by an attorney with a docket number 210407.0052/052 US) is hereby incorporated by reference.

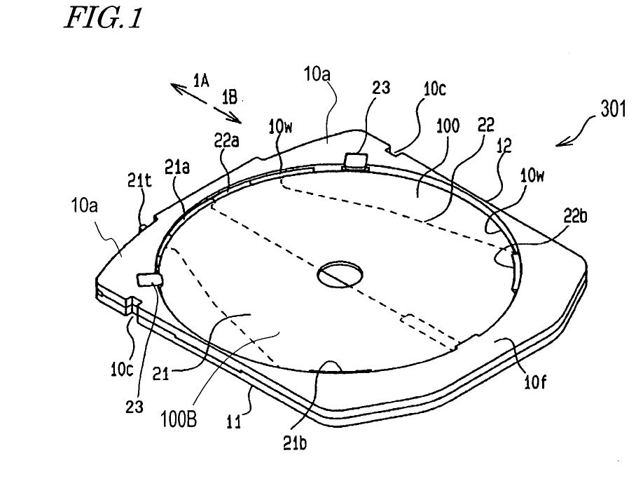

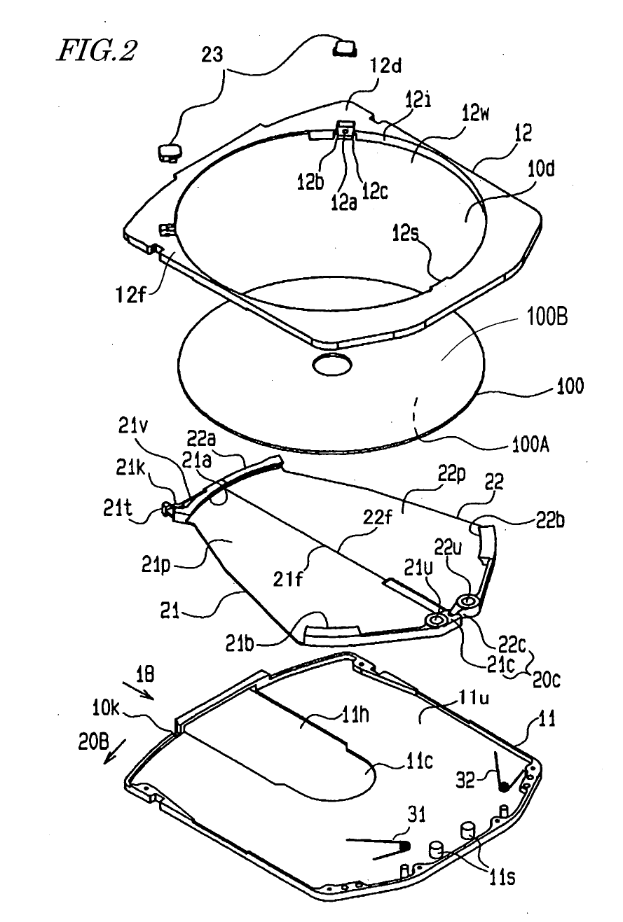

FIGS. 1 and 2 are respectively a perspective view and an exploded perspective view illustrating an exemplary disc cartridge 301 for use in the present invention. First, the structure of the disc cartridge 301 will be outlined with reference to FIGS. 1 and 2.

The disc 100 shown in FIGS. 1 and 2 includes first and second sides. The first side of the disc, i.e., a label side 100B on which its label is normally printed, is illustrated in FIG. 1, while the second side of the disc 100, i.e., the data recording side 100A, is illustrated as the back surface in FIG. 2.

As shown in FIGS. 1 and 2, the disc cartridge 301 includes a cartridge lower shell 11, a cartridge upper shell 12, a pair of shutters 21 and 22 and stopper portions 23.

As shown in FIG. 2, the cartridge lower shell 11 includes a chucking opening 11c and a head opening 11h. The chucking opening 11c is provided to allow a chucking member (e.g., a spindle motor for rotating the disc 100) to enter the disc cartridge 301 externally. The head opening 11h is provided to allow a head, which reads and/or writes data from/on the data recording side 100A of the disc 100, to enter the disc cartridge 301 and access the data recording side 100A. The cartridge lower shell 11 faces the data recording side 100A of the disc 100. Also, the head opening 11h reaches a side surface of the cartridge lower shell 11.

The cartridge upper shell 12 includes a circular disc window 12w, through which the disc 100 can be introduced and removed into/from the disc cartridge 301 and which expands over the entire projection area of the disc 100 to expose the upper surface of the disc. The cartridge upper and lower shells 12 and 11 are adhered or welded together at their outer periphery, thereby forming a cartridge body 10.

A disc storage portion 10d for storing the disc 100 therein is defined by a first inner surface 11u of the cartridge lower shell 11 and a second inner surface 12i of the cartridge upper shell 12. The first inner surface 11u is opposed to the data recording side 100A of the disc 100, while the second inner surface 12i has a substantially cylindrical shape and defines the disc window 12w inside. That is to say, the first inner surface 11u becomes the bottom of the disc storage portion 10d.

In the disc storage portion 10d, a gap, which is wide enough to allow the disc 100 to rotate freely, is provided between the second inner surface 12i and the disc 100. Also, the top of the disc storage portion 10d is the disc window 12w so that the disc 100 stored in the disc storage portion 10d has one side thereof exposed through the disc window 12w.

The stopper portions 23 are provided in a removable state for the cartridge upper shell 12 so as to partially protrude into the disc window 12w. In this embodiment, two stopper portions 23 are provided as shown in FIGS. 1 and 2. On the other hand, another stopper portion 12s is provided for the cartridge upper shell 12 so as to protrude into the disc window 12w. The stopper portion 12s forms an integral part of the cartridge upper shell 12. The two stopper portions 23 and the stopper portion 12s are arranged approximately at regular intervals around the circumference of the disc window 12w for the purpose of preventing the disc 100 from dropping down from the disc window 12w whether the shutters are closed or opened. These stopper portions 23 and 12s can prevent the dropping particularly effectively when this disc cartridge is vertically loaded into a disc drive and used.

The shutters 21 and 22 are provided between the data recording side 100A of the disc 100 and the inner surface 11u of the disc storage portion 10d. The shutters 21 and 22 include rotation holes 21u and 22u, respectively. These rotation holes 21u and 22u are engaged in a freely rotatable state with a pair of rotation shafts 11s, which is located outside of the disc storage portion 10d of the cartridge body 10 and opposite to the head opening 11h. Thus, the shutters 21 and 22 rotate on the rotation shafts 11s so as to expose or cover the chucking and head openings 11c and 11h.

A cam 21c and a follower 22c are provided near the rotation holes 21u and 22u of the shutters 21 and 22, respectively. The cam 21c and the follower 22c have mutually engaging shapes and together make up an interlocking mechanism 20c for opening and closing the shutters 21 and 22 while interlocking them with each other.

The respective surfaces of the shutters 21 and 22, which are opposed to the data recording side 100A of the disc, are covered with protective layers 21p and 22p for the purpose of preventing the disc 100 from getting scratched or any dust from entering the data recording side 100A thereof.

The protective layers 21p and 22p may be appropriately selected from the group consisting of an anti-scratching nonwoven fabric, a dustproof nonwoven fabric, an anti-scratching coating layer and a dustproof coating layer. In this embodiment, sheets of a dustproof nonwoven fabric are adhered or ultrasonic welded as the protective layers 21p and 22p.

Shutter springs 31 and 32 are provided outside of the disc storage portion 10d for the shutters 21 and 22, respectively. These springs 31 and 32 apply an elastic force to the shutters 21 and 22 in such a direction as to close the shutters 21 and 22. Optionally, the elastic force may also be applied from any other type of elastic members to the shutters 21 and 22 in that closing direction.

As shown in FIG. 2, the disc cartridge 301 includes disc holding portions 21a, 21b, 22a and 22b at both ends of the shutters 21 and 22. Each of these disc holding portions 21a, 21b, 22a and 22b has a downwardly tapered slope at the end of the shutter 21 or 22 to grip the outer edge of the disc 100 while the shutters 21 and 22 are closed. The structure and operation of the disc holding portions 21a, 21b, 22a and 22b will be described in further detail later.

As shown in FIG. 1, the upper surface 10f of the cartridge body 10 (or the cartridge upper shell 12) is parallel to the disc 100 to be stored. In addition, two concave portions 10c are further provided on two of the side surfaces of the cartridge body 10. These concave portions 10c may be used as either pull-in notches or positioning recesses when the disc cartridge 301 is loaded into a disc drive or when the cartridge 301 is stored in a changer.

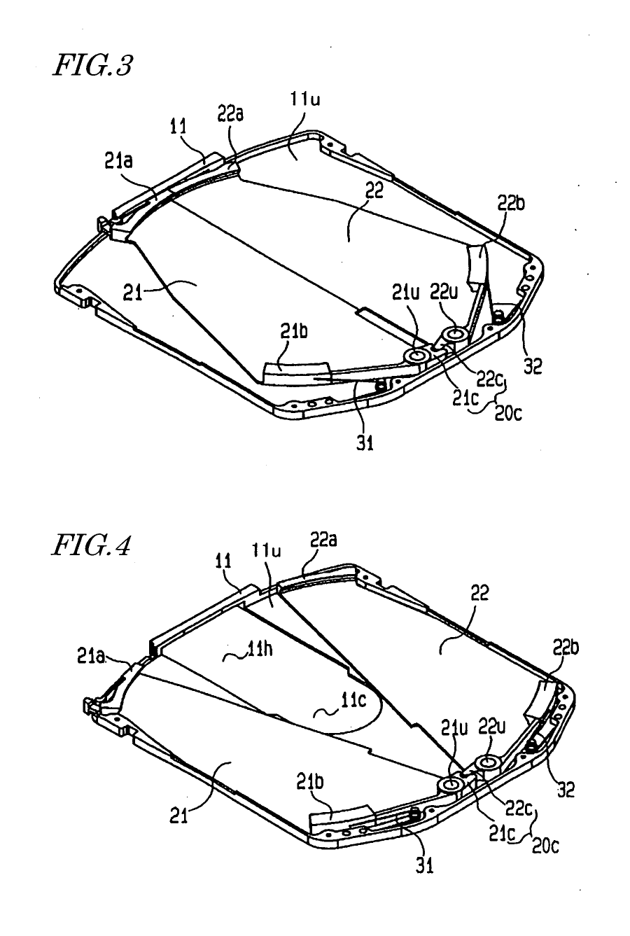

FIG. 3 is a perspective view illustrating a state where the shutters 21 and 22 cover the chucking and head openings 11c and 11h with the cartridge upper shell 12 and the disc 100 removed. In FIG. 3, the disc holding portions 21a, 21b, 22a and 22b of the shutters 21 and 22 are located at such positions as to grip the outer edge of the disc 100 (not shown).

FIG. 4 is a perspective view illustrating a state where the shutters 21 and 22 expose the chucking and head openings 11c and 11h with the cartridge upper shell 12 and the disc 100 removed. As a result of the rotation of the shutters 21 and 22 on their rotation holes 21u and 22u, respectively, the chucking and head openings 11c and 11h are now exposed. Also, as the shutters 21 and 22 have rotated, the disc holding portions 21a, 21b, 22a and 22b have also rotated on the rotation holes 21u and 22u. Consequently, the disc holding portions 21a, 21b, 22a and 22b are now separated from the outer edge of the disc 100 (not shown).

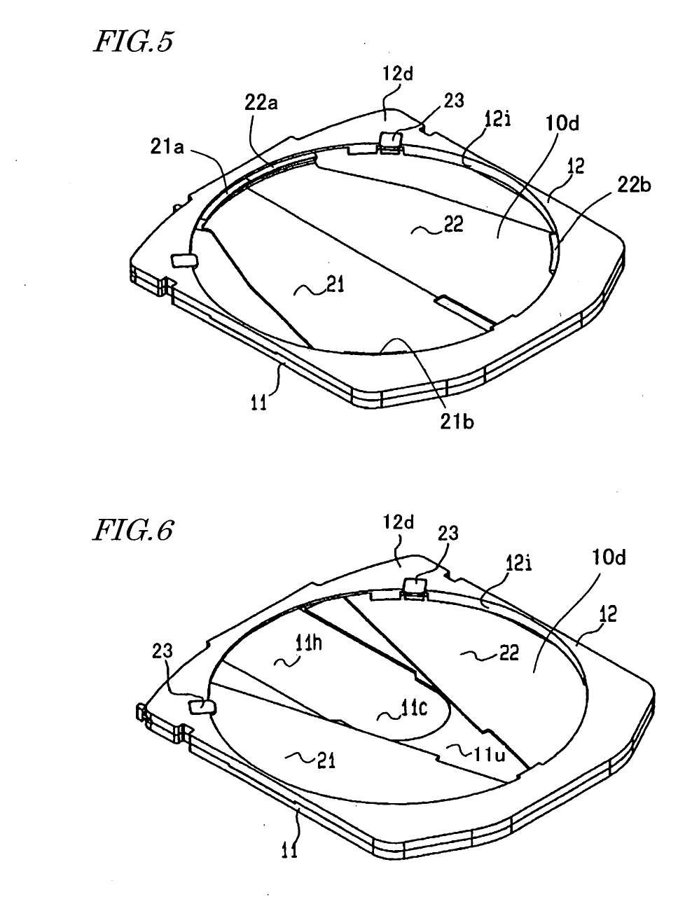

FIG. 5 is a perspective view illustrating a state where the shutters 21 and 22 cover the chucking and head openings 11c and 11h with the disc 100 removed. As shown in FIG. 5, the disc holding portions 21a, 21b, 22a and 22b protrude into the disc storage portion 10d to hold the disc 100 (not shown) thereon. On the other hand, FIG. 6 is a perspective view illustrating a state where the shutters 21 and 22 expose the chucking and head openings 11c and 11h with the disc 100 removed. As shown in FIG. 6, while the shutters 21 and 22 are opened, the disc holding portions 21a, 21b, 22a and 22b are stored outside of the disc storage portion 10d of the cartridge body.

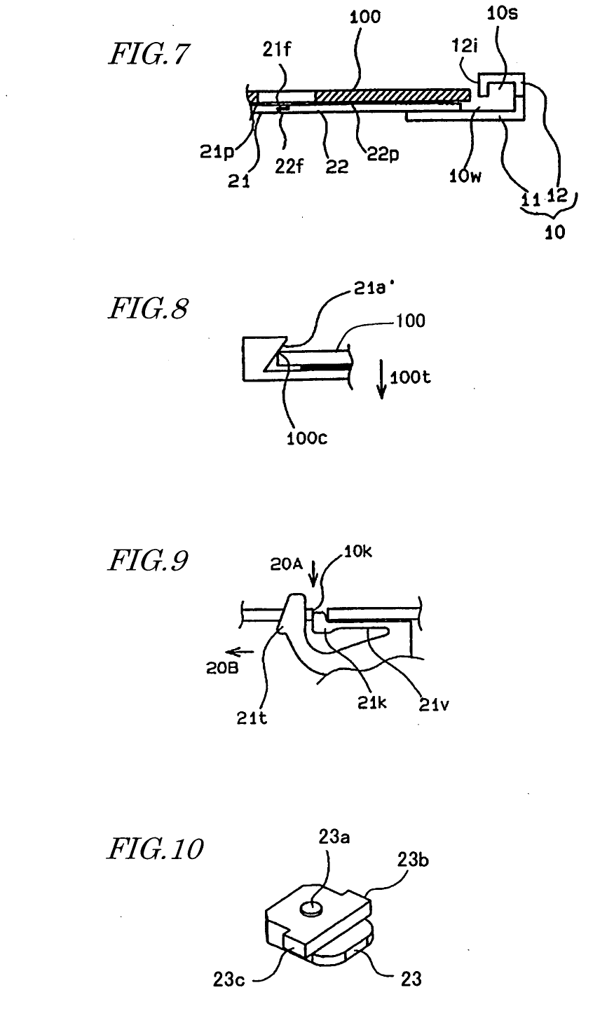

Next, the structure and the operation of the shutters 21 and 22 will be described in further detail with reference to FIGS. 7, 8 and 9. FIG. 7 is a cross-sectional view as viewed along a plane that passes the center of the disc 100 stored in the disc cartridge 301. As shown in FIG. 7, the second inner surface 12i of the disc storage portion 10d of the cartridge body 10 is provided with a notch 10w so as not to interfere with the opening and closing operations of the shutter 22 or 21. Also, the cartridge body 10 further includes a shutter storage portion 10s for storing a portion of the shutter 22 or 21 being opened. Furthermore, at least the edge portions 21f and 22f of the shutters 21 and 22, which are butted against each other over the head and chucking openings 11h and 11c while the shutters are closed, overlap with each other in the thickness direction of the disc 100 as shown in FIG. 7.

On the other hand, as shown in FIG. 8, each of the disc holding portions 21a, 21b, 22a and 22b includes a slope 21a′, 21b′, 22a′ or 22b′, which overhangs a portion of the projection area of the disc and overlaps with the outer edge of the disc 100. That is to say, the slope 21a′ has a downwardly tapered shape and leans toward the disc 100. While the chucking and head openings 11c and 11h are covered with the shutters 21 and 22, the slope 21a′ is allowed to contact with the outer edge 100c of the disc 100, thereby gripping the disc 100 thereon and pressing the disc 100 in the thickness direction loot. In this manner, the data recording side 100A is brought into plane contact with the sheets 21p and 22p of the shutters 21 and 22 and the disc 100 is held and fixed onto the cartridge body 10. In such a state, the data recording side 100A of the disc 100 is in close contact with the sheets 21p and 22p. Thus, no dust will be deposited on the data recording side 100A.

Also, if the exposed side of the disc 100 is rotated manually or if the shutters 21 and 22 are opened or closed intentionally, then dust, finger marks or any other dirt that has adhered onto the data recording side 100A of the disc 100 may be wiped away.

Furthermore, as shown in FIG. 9, the shutter 21 includes a shutter opening/closing portion 21t, an elastic portion 21v and a locking protrusion portion 21k. These portions 21t, 21v and 21k form integral parts of the shutter 21. Specifically, the shutter opening/closing portion 21t is used to open and close the shutters externally. The locking protrusion portion 21k is connected to the shutter 21 by way of the elastic portion 21v. While the shutter 21 covers the chucking and head openings 11c and 11h, the locking protrusion portion 21k, to which an elastic force is being applied from the elastic portion 21v, engages with a locking hole 10k of the cartridge body 10, thereby preventing the shutter 21 from rotating and fixing and supporting the shutter 21 to the cartridge body 10 as shown in FIG. 9. Once the shutter 21 is fixed, the other shutter 22, which is interlocked with the shutter 21 via the interlocking mechanism 20c, is also fixed.

Accordingly, only by getting the locking protrusion portion 21k pressed externally by a protrusion, for example, in the direction indicated by the arrow 20A and disengaged from the locking hole 10k while pressing the opening/closing portion 21t in the direction indicated by the arrow 20B at the same time, the shutters 21 and 22 can be rotated to expose the chucking and head openings 11c and 11h and the disc 100 can be released from the disc holding portions 21a, 21b, 22a and 22b. Thus, it is possible to prevent the operator from removing the disc accidentally.

Next, the structure and operation of the stopper portions 23 will be described in further detail with reference to FIGS. 2 and 10. FIG. 10 is a perspective view illustrating the removable stopper portion 23 upside down. The convex portions 23a, 23b and 23c of the stopper portion 23 are respectively engaged with concave portions 12a, 12b and 12c provided for the cartridge upper shell 12 near the disc window 12w thereof as shown in FIG. 2. Thus, the stopper portion 23 can be removed from the cartridge upper shell 12.

As described above, the disc cartridge for use in the present invention includes the disc storage portion that stores a disc therein with its label side fully exposed. On the bottom of the disc storage portion, the head opening for allowing a read/write head to access the data recording side of the disc, and the chucking opening for allowing a motor to access the disc and rotate it are provided. Unless this disc cartridge is loaded into a disc drive for reading or writing purposes, the head and chucking openings are always covered with the shutters. Also, the disc is gripped by the disc holding portions so as not to move within the disc storage portion. The stopper portion protrudes into the disc window and can prevent the disc from dropping through the disc window no matter whether the shutters are opened or closed.

### Embodiment 1

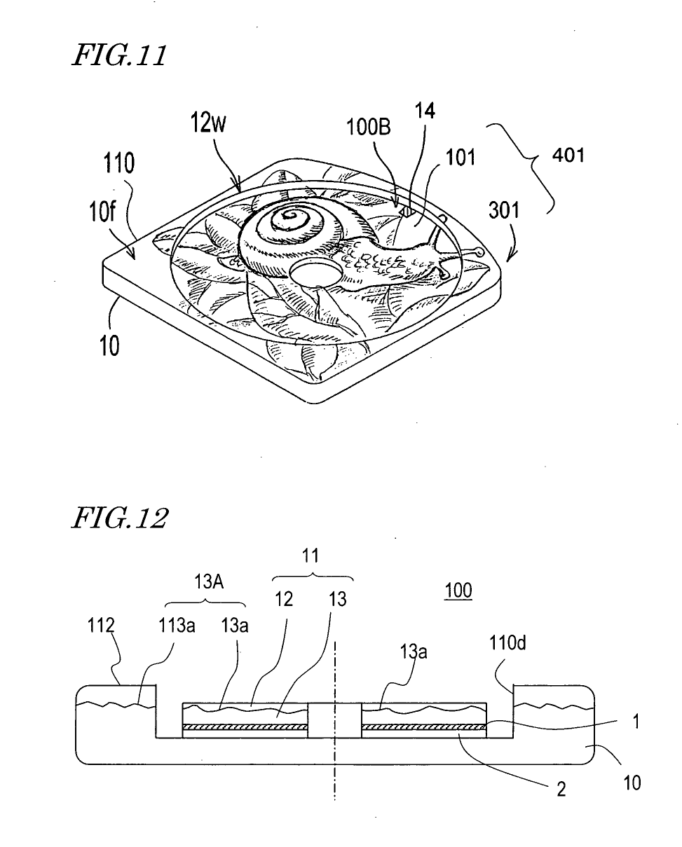

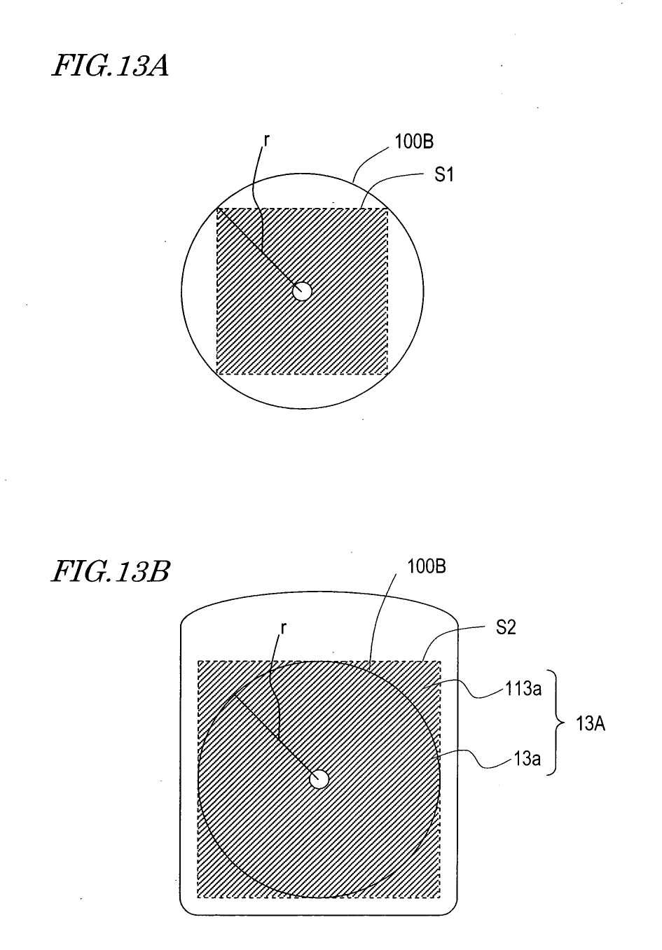

Hereinafter, a first embodiment of the present invention will be described. FIG. 11 is a perspective view illustrating a data storage medium 401 including a disc 101 and a disc cartridge 301 to store the disc 101 therein. FIG. 12 shows a cross section of the data storage medium 401 as taken in the thickness direction thereof.

The disc cartridge 301 has the same structure as the disc cartridge 301 that has already been described with reference to FIGS. 1 through 10. The disc cartridge 301 stores the disc 101 therein such that the label side 100B of the disc 101 is fully exposed through the disc window 12w of the disc cartridge 301. Although not shown in FIG. 11, the disc holding portions 21a, 22b, 22a and 22b provided for the shutters 21 and 22 of the disc cartridge 301 hold the disc 101 thereon while the data storage medium 401 is not yet inserted into a disc drive for reading and writing purposes as described above.

As shown in FIG. 2, the disc 101 includes a data storage layer 1, a first substrate 11 and a second substrate 2. The data storage layer 1 is sandwiched between the first and second substrates 11 and 2. The second substrate 2 has a data recording side 100A. On the other hand, the first substrate 11 has a label side 100B.

The first substrate 11 includes a first layer 13, of which the surface is provided with an embossed design 13a including concave and convex portions, and a second layer 12, which is transparent and covers the surface of the first layer 13. The second layer 12 fills the unevenness of the design 13a and has a flat surface. The concave and convex portions of the design 13a have level differences of 0.2 mm to 1 mm. The first substrate 11 overall preferably has a thickness of at least 0.5 mm and more preferably has a thickness of 0.8 mm to 1.4 mm. The design 13a is the first functional portion provided for the label side 100B.

The upper surface 10f with the disc window 12w of the cartridge body 10 of the disc cartridge 301 is provided with an embossed design 113a including concave and convex portions. The surface of the design 113a is covered with a transparent portion 112. The design 113a is the second functional portion provided for the disc cartridge 301. The cartridge body 10 and the first substrate 11 of the disc 101 may be formed by molding polycarbonate, ABS resin or any other suitable material.

The design 13a as the first functional portion and the design 113a as the second functional portion are combined together to make up a design 13A that looks like a single continuous design. In other words, the designs 13a and 113a cooperate with each other, thereby producing a visual effect. In the example illustrated in FIG. 11, the designs 113a and 13a together make up a picture 13A of a snail creeping on a leaf. The designs 113a and 13a and the unified design 13A may be a picture, photo or pattern related to the music or video stored on the data storage layer 1 beforehand. To unify the combined designs 113a and 13a even more perfectly, the substrate 11 and the cartridge body may be made of the same material. Also, to increase the degree of unification and the visual effect, the embossed patterns of the designs 13a and 113a preferably have the same depth.

By providing such continuous designs 113a and 13a in this manner, the design 13A, greater than the label side 100B of the disc 100, can be presented on the surface of the disc cartridge 301 with the disc window 12w.

In particular, if only the label side 100B is provided with a design, the design must be confined within the circular border of the disc. In contrast, according to this preferred embodiment, the design 13A may have its shape defined by the configuration of the disc cartridge 301. For example, in providing a design that is defined by a substantially rectangular configuration, the largest possible design that can be provided on the label side 100B will be a square that is circumscribed by a circle defined by the label side 100B as shown in FIG. 13A. In that case, supposing the radius of the label side 100B is r, each side of the square S1 has a length of ≈√2r.

On the other hand, if the design can also be provided on the upper surface of the disc cartridge 301, then the configuration of the smallest design may be defined by a square S2 that is inscribed by the circular label side 100B as shown in FIG. 13B. That is to say, the design can be provided within the square S2, each side of which has a length of 2r. Thus, the area of the square S2 is twice greater than that of the square S1. As a result, a greater visual effect is achievable.

In addition, by presenting the unified design 13A over the disc cartridge 301 and disc 100 that are not a single member but two separate members, a high visual effect is achieved.

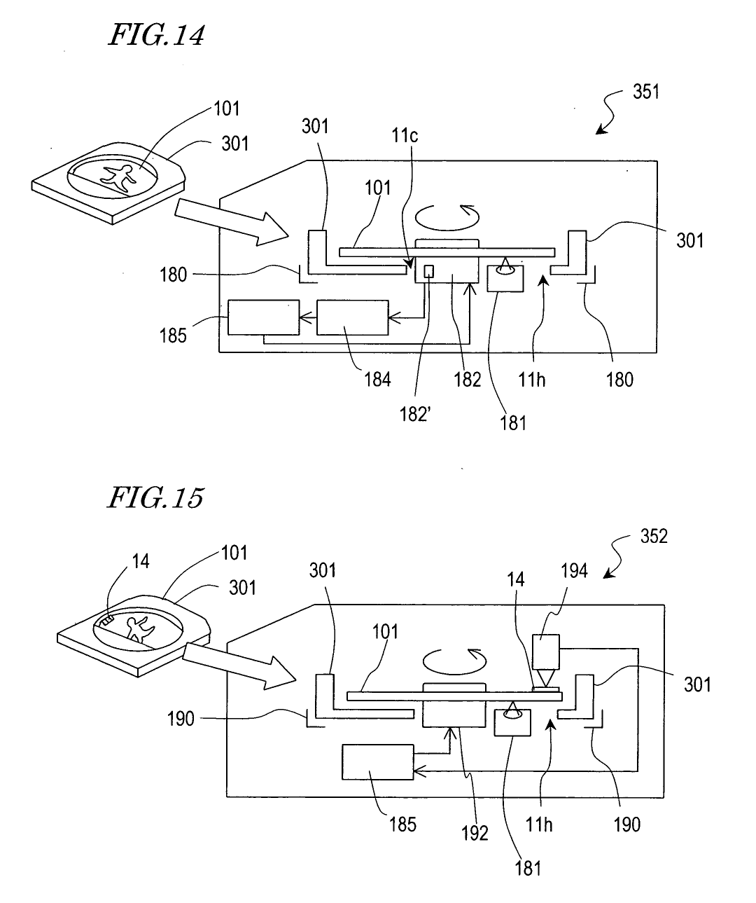

To achieve such a visual effect, the disc 101 is preferably held by the disc cartridge 301 such that the designs 113a and 13a make up one continuous design 13A. For that purpose, reading and/or writing from/on the disc 101 in the disc cartridge 301 is preferably carried out with the disc drive 351 shown in FIG. 14.

The disc drive 351 includes: a supporting portion 180 into which the disc cartridge 301 is loadable; a spindle motor 182 for mounting and rotating the disc 101 stored in the disc cartridge 301; and an optical head 181, which can read and/or write data from/on the data storage layer of the disc 101. The spindle motor 182 is provided with a sensor 182′ for detecting the rotational angle of the spindle motor 182. The disc drive 351 further includes a rotational angle detector 184 for calculating the rotational angle based on the output of the sensor 182′ and a control section 185 for controlling the rotational angle of the spindle motor 182 in accordance with the angle detector 184. Although not shown in FIG. 14, the disc drive 351 further includes other components that are included in any conventional disc drive.

As already described with reference to FIGS. 1 through 10, when the disc cartridge 301 is loaded into the disc drive 351, the shutters 21 and 22 of the disc cartridge 301 are opened so that the optical head 181 can access the data recording side 100A of the disc 101 through the head opening 11h. At the same time, the disc 101 is mounted on the spindle motor 182 through the chucking opening 11c.

In the meantime, as the shutters 21 and 22 are opened, the disc holding portions 21a, 22b, 22a and 22b provided for the shutters 21 and 22 release the disc 101. Also, the rotational angle of the spindle motor 182 when the disc 101 is mounted on the spindle motor 182 is detected by the angle detector 184.

When the optical head 181 finishes its read and/or write operation, the control section 185 stops the spindle motor at the rotational angular position that has been detected by the angle detector 184. Subsequently, as the shutters 21 and 22 are closed, the disc holding portions 21a, 22b, 22a and 22b provided for the shutters 21 and 22 hold and fix the disc 101 thereon. As a result, the disc 101 is fixed onto the disc cartridge 301 such that the design 13a provided on the label side of the disc 101 continues with the design 113a provided on the upper surface of the cartridge. Thereafter, the disc cartridge 301 is ejected from the disc drive 351.

In this manner, if this disc drive 402 is used, the rotational angular position of the disc 101 with respect to the disc cartridge 301 before the disc cartridge 301 is inserted into the disc drive 402 is the same as its position after the disc cartridge 301 has been ejected from the disc drive 402. Thus, the disc 101 is held by the disc cartridge 301 such that the design 13a provided on the label side of the disc 101 always looks continued with the design 113a provided on the upper surface of the cartridge body. As a result, the disc cartridge can look even more beautiful and a higher visual effect is achieved.

Alternatively, the disc drive 352 shown in FIG. 15 may also be used to read and/or write data from/on the disc 101 stored in the disc cartridge 301. If this disc drive 352 is used, an angle mark 14 is made in advance on the label side 100B of the disc 101.

The disc drive 352 includes: a supporting portion 190 into which the disc cartridge 301 is loaded; a spindle motor 192 for mounting and rotating the disc 101 stored in the disc cartridge 301; and an optical head 181, which can read and/or write data from/on the data storage layer of the disc 101.

The disc drive 352 further includes an angle detector 194 for detecting the angle mark 14 on the label side 100B of the disc 101 and a control section 185. Although not shown in FIG. 15, the disc drive 352 further includes other components that are included in any conventional disc drive.

After the optical head 181 has finished its read and/or write operation, the control section 185 starts the operation of stopping the spindle motor 192. When the rotational velocity of the spindle motor 192 becomes lower than a predetermined velocity, the control section 185 stops the spindle motor 192 completely at the rotational angular position at which the angle detector 184 has detected the angle mark 14. As a result, the disc 101 can always be stopped at the same rotational angular position no matter where the rotational angular position of the disc 101 is when the disc cartridge 301 is loaded into the disc drive 352.

Accordingly, if the location of the angle mark 14 is determined such that the design 13a provided on the label side of the disc 101 and the design 113a provided on the upper surface of the cartridge body make up a single continuous design 13A at this rotational angular position, then the design 13a provided on the label side of the disc 101 and the design 113a provided on the upper surface of the cartridge always form a single continuous design 13A in the disc cartridge 301 ejected from the disc drive 352. Thus, the disc 101 is held by the disc cartridge 301 such that the design 13a provided on the label side of the disc 101 always looks continued with the design 113a provided on the upper surface of the cartridge. As a result, the disc cartridge can look even more beautiful and a higher visual effect is achieved.

It should be noted that the design 113a does not have to be provided at just one location with respect to the design 13a, which looks like a single continuous one by combining together the designs 13a and 113a on the label side of the disc 101 and on the upper surface of the cartridge, respectively. For example, the designs 13a and 113a may be arranged so as to look unified at two locations where the rotational angles of the disc 101 with respect to the disc cartridge 301 are 0 degrees and 180 degrees, respectively. Alternatively, the designs 13a and 113a may make up unified designs 13A at an even larger number of locations. Optionally, the designs 13a and 113a may also be arranged so as to look unified irrespective of the rotational angle at which the disc 101 stops with respect to the disc cartridge 301. In that case, the combined design can always look unified and produce the desired visual effect without using the disc drive 351 or 352.

In the preferred embodiment described above, the designs 13a and 113a provided on the label side 100B of the disc 101 and on the upper surface of the cartridge are embossed patterns with concave and convex portions. Alternatively, the designs 13a and 113a may also be provided as normal flat printings or textured ones. Even if the designs 13a and 113a are planar ones, the intended effects are also achievable by making the two designs cooperate with each other as described above. In that case, the first substrate 11 of the disc 101 may have an overall thickness of 0.5 mm or less, and the disc 101 may be CD, for example. As another alternative, each of the designs 113a and 13a may also be a hologram that includes a pattern consisting of many fine grooves engraved on the surface of the label side 100B and multiple transparent plates and drawing pattern layers that are stacked under that pattern.

In the preferred embodiment described above, the surfaces of the designs 13a and 113a are covered with the transparent second substrate 12 and the transparent portion 112, respectively. However, the second transparent substrate 12 and the transparent portion 112 may be omitted. In that case, the concave and convex portions of the designs 13a and 113a will be exposed on the label side 100B of the disc 101 and on the upper surface 10f of the disc cartridge 301, respectively. As a result, a tactual effect is also achieved.

In the preferred embodiments described above, the first functional portion of the disc and the second functional portion of the disc cartridge cooperate with each other, thereby achieving an audiovisual effect. However, if a non-planar first functional portion can be provided for the disc by setting the thickness of the first substrate 11 equal to or greater than 0.5 mm, then the disc itself, including the first functional portion, can achieve a novel and excellent audiovisual effect. More specifically, if a design with the embossed structure as described above is provided as the second functional portion on the label side of the disc, then excellent visual effects, which could not be produced by any conventional disc, are achievable by the stereoscopic design. Accordingly, even without making the first functional portion cooperate with the second functional portion, a disc with a lot of attraction for buyers can be obtained.

In another exemplary disc of which the first functional portion can achieve excellent visual effects by itself, the first layer 13 of the first substrate 11 may be made of a material that functions as a carrier for supporting the data storage layer 1 thereon, while the second layer 12 thereof may be made of a film on which a scratch mark can be easily left with a coin or a fingernail. Various types of information may be provided for a disc 101 with such a structure.

For example, if a disc 101 is manufactured so as to have such a structure, the result of a warpage, eccentricity or center of mass test on the disc 101 may be left as a scratch mark on the second layer 12. In that case, the location of warpage, eccentricity or center of mass may be represented by the location of the scratch mark. Also, the degree of warpage or eccentricity may also be represented by the size or the number of such scratch marks.

As another alternative, various types of character information, for example, may be printed on the surface of the first layer 13 and may be coated with the second layer 12. In that case, by scratching the second layer 12 off with a coin or a fingernail, the character information can be disclosed. As the character information, a quiz answer, a lottery winning mark or foretold future (or fortune) may be printed.

### Embodiment 2

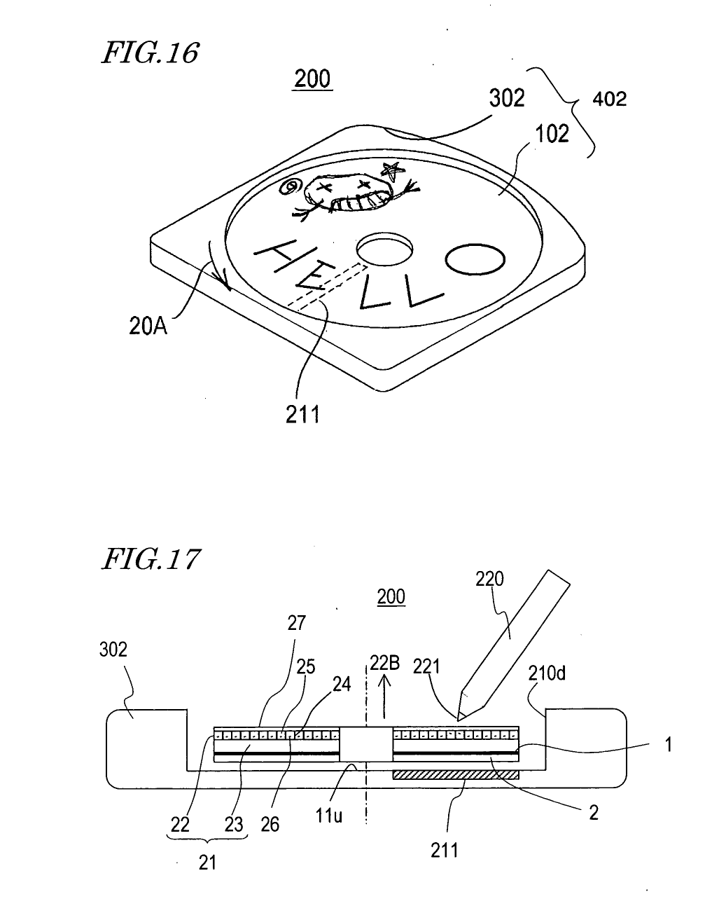

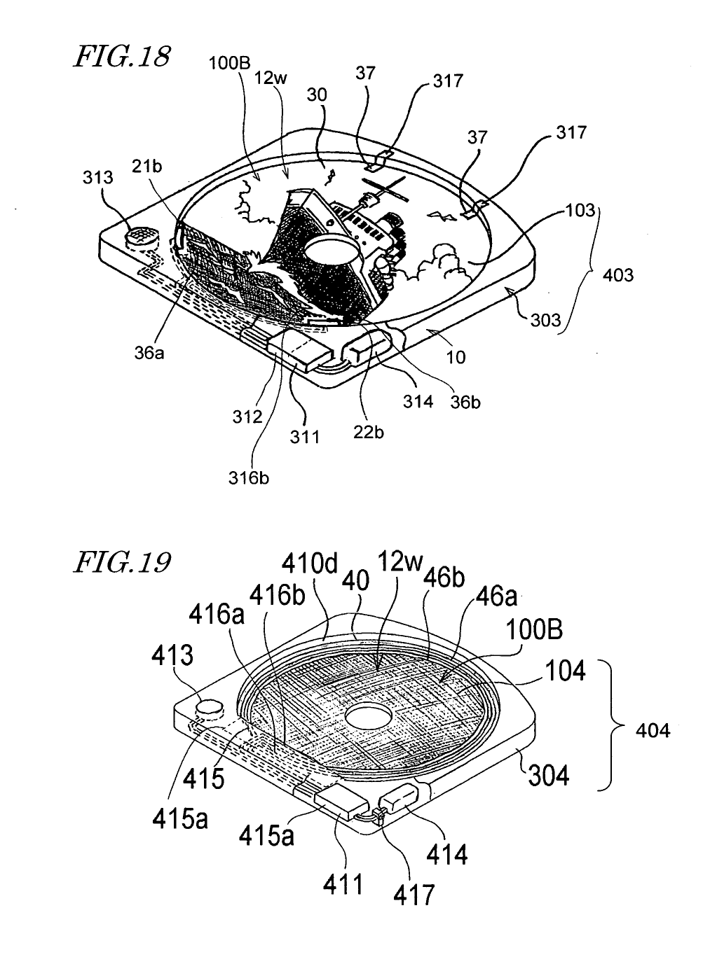

Hereinafter, a disc cartridge according to a second embodiment of the present invention will be described. FIG. 16 is a perspective view illustrating a data storage medium 402 including a disc 102 and a disc cartridge 302 to store the disc 102 therein. FIG. 17 shows a cross section of the data storage medium 402 as taken in the thickness direction thereof.

The disc cartridge 302 has the same structure as the disc cartridge 301 that has already been described with reference to FIGS. 1 through 10. The disc cartridge 302 stores the disc 102 therein such that the label side 100B of the disc 102 is fully exposed through the disc window 12w of the disc cartridge 311.

As shown in FIG. 17, the disc 102 includes a data storage layer 1, a first substrate 21 and a second substrate 2. The data storage layer 1 is sandwiched between the first and second substrates 21 and 2. The second substrate 2 has a data recording side 100A. On the other hand, the first substrate 21 has a label side 100B.

The first substrate 21 includes a substrate layer 23, which functions as a carrier for supporting the data storage layer 1 thereon, and a tablet 22, which is provided on the surface of the substrate layer 23 and on/from which traces representing characters, pictures and so on can be drawn and erased. The tablet 22 includes a group of small rooms 24, each of which has a viscous fluid 25 and a magnetic powder 26 and which are arranged like a honeycomb, for example, and a transparent sheet 27 that covers the upper surface of the small rooms 24. The tablet 22 functions as the first functional portion.

As shown in FIG. 17, a magnet plate 211, which is at least as long as the radial length of the tablet 22, is provided on the bottom 11u of the disc storage portion of the disc cartridge 302 so as to face the data recording side 100A of the disc 102. The magnet plate 211 does not have to have its surface exposed on the bottom 11u but may be embedded under the bottom 11u. The magnet 211 functions as the second functional portion and erases the pictures, characters and so on that have been drawn on the tablet 22.

In the disc cartridge 302 that stores the disc 102 therein, the tablet 22 as the first functional portion and the magnet 211 as the second functional portion cooperate with each other so as to function as an erasable tablet. More specifically, when the user brings a touch pen 220, including a magnet 221 at its tip, into contact with the surface of the tablet 22, the magnetic powder 26 in the small rooms 24 is attracted toward the surface of the tablet 22. As a result, the small rooms 24 including the attracted magnetic powder 26 turn into black (or the color of the colored magnetic powder). Accordingly, as the touch pen 220 moves, its traces are displayed in black. In this manner, the user can draw characters, graphics and so on with the touch pen 220.

As shown in FIG. 16, if the disc 102 stored in the disc cartridge 302 is forced to make one rotation in the direction indicated by the arrow 20A, then the magnet plate 211 separates the magnetic powder 26 away from the surface of the tablet 22. As a result, the characters, graphics and so on that have been displayed on the tablet 22 are erased.

On the other hand, if the disc cartridge 302 including the disc 102 is loaded into a disc drive so as to start reading and/or writing therefrom/thereon, then the disc 102 will be lifted in the direction indicated by the arrow 22B shown in FIG. 17 so as to be mounted on the spindle motor while being separated from the bottom 11u of the disc storage portion. Thus, the magnetic force of the magnet plate 211 acting on the magnetic powder 26 is not strong enough to separate the magnetic powder 26 from the surface of the tablet 22. As a result, even if the disc 102 is rotated by the spindle motor, the characters, graphics, etc. on the tablet 22 are kept as they are.

Thus, according to this preferred embodiment, information about the contents of the disc 102 (e.g., information about the musical tunes or video stored on the disc 102) can be directly written down on the label side 100B (i.e., the surface) of the disc 102, and the information once written may be erased if necessary. The information writable area covers almost all of the label side 100B and is sufficiently wide. Accordingly, excellent audiovisual effects are achieved by the tablet 22 and magnet plate 211. In the prior art, such information is noted down on a small piece of sticker and then the sticker is put onto a disc cartridge. As compared with such a method, it is much easier to write down information or erase or rewrite the information once written.

In the preferred embodiment described above, the tablet 22 is designed so as to allow the user to write down characters, graphics and so on there freely. Alternatively, a transparent coordinate input sheet may be provided on the surface of the tablet 22 such that character or graphic data may be input as coordinate data.

### Embodiment 3

Hereinafter, a disc cartridge according to a third embodiment of the present invention will be described. FIG. 18 is a perspective view illustrating a data storage medium 403 including a disc 103 and a disc cartridge 303 to store the disc 103 therein.

The disc cartridge 303 has the same structure as the disc cartridge 301 that has already been described with reference to FIGS. 1 through 10. The disc cartridge 303 stores the disc 103 therein such that the label side 100B of the disc 103 is fully exposed through the disc window 12w of the disc cartridge 303.

As shown in FIG. 18, the disc 103 includes a display device 30 as the first substrate on its label side 100B. The display device 30 is preferably a matrix-addressed display device, which includes an organic EL, inorganic EL or liquid crystal material. The display device 30 functions as the first functional portion.

The disc cartridge 303 includes a loudspeaker 313, a control section 311 for controlling the display on the display device 30, a memory 312 on which image information to be presented on the display device 30 and audio information to be reproduced through the loudspeaker 313 is stored, and a power supply 314 for supplying power to these components. These components are all stored in the cartridge body 10 and function as the second functional portion. The image information and audio information may be related to the contents of the disc 103 (e.g., musical tunes or video stored on the disc 103). Optionally, the memory 312 may also be removable discrete memory which is attachable to, and removable from, the cartridge body 10.

As shown in FIG. 18, body-side terminals 316a and 316b connected to the control section 311 are provided on the slopes of the disc holding portions 21b and 22b of the shutters 21 and 22, respectively. On the label side 100B of the disc 103, disc-side terminals 36a and 36b are provided so as to face the body-side terminals 316a and 316b, respectively.

Furthermore, the cartridge body 10 is provided with a pair of body-side marks 317 and the disc 103 is provided with a pair of disc-side marks 37. When the disc 103 is located at such a rotational angular position that the body-side terminals 316a and 316b contact with the disc-side terminals 36a and 36b, respectively, the disc-side marks 37 are aligned with the body-side marks 317.

While the disc cartridge 303 storing the disc 103 therein is not loaded in a disc drive, the disc 103 is held by the disc holding portions. In this case, if the body-side marks 317 are aligned with the disc-side marks 37 by rotating the disc 103, then the body-side terminals 316a and 316b contact with the disc-side terminals 36a and 36b, respectively. As a result, in accordance with the data stored in the memory 312, an image is presented on the display device 30 and sound is reproduced through the loudspeaker 313. Also, if the body-side marks 317 are shifted from the disc-side marks 37 by rotating the disc 103, then the display of the image and the reproduction of the sound can be stopped.

In getting read and/or write operations started by loading the disc cartridge 303 including the disc 103 into a disc drive, as the shutters 21 and 22 are going to be opened, the disc holding portions gradually release the disc 103. As a result, the disc holding portions 21b and 22b retract so as not to contact with the disc 103. Accordingly, even if the disc 103 rotates, the body-side terminals 316a and 316b will not contact with the disc-side terminals 36a and 36b.

In this manner, according to this embodiment, by using the display device provided on the label side of the disc and the power supply, control section and loudspeaker, which are provided for the disc cartridge to present an image on the display device, a moving picture, for example, can be presented on the display section and sound can be reproduced through the loudspeaker. That is to say, the disc cartridge 303 including the disc 103 can be a more attractive product by increasing the audiovisual effects of the disc cartridge 303. Particularly when the image to be displayed is related to a movie, for example, stored on the disc 103, the contents of the disc 103 can be presented even more effectively.

### Embodiment 4

Hereinafter, a disc cartridge according to a fourth embodiment of the present invention will be described. FIG. 19 is a perspective view illustrating a data storage medium 404 including a disc 104 and a disc cartridge 304 to store the disc 104 therein.

The disc cartridge 304 has the same structure as the disc cartridge 301 that has already been described with reference to FIGS. 1 through 10. The disc cartridge 304 stores the disc 104 therein such that the label side 100B of the disc 104 is fully exposed through the disc window 12w of the disc cartridge 304.

As shown in FIG. 19, the disc 104 includes a planar loudspeaker 40 as the first substrate on its label side 100B. The planar loudspeaker 40 functions as the first functional portion.

The disc cartridge 304 includes a microphone 413, a control section 411 for converting audio information and driving the planar loudspeaker 40, a memory 412 in which the audio information is stored, a power supply 414 for supplying power to these components, and a switch 417 for electrically connecting the power supply 414 to the control section 411. The switch 417 can also switch a mode in which sound is recorded with the microphone 413 into a mode in which the audio information stored in the memory 412 is reproduced, or vice versa. These components are stored in the cartridge body 10 and function as the second functional portion. The audio information may be related to the contents of the disc 103 (e.g., musical tunes or video stored on the disc 103).

The disc cartridge 304 further includes a stopper portion 415, which protrudes into the disc window 12w. On the inside surface of the stopper portion 415, body-side terminals 416a and 416b, connected to the control section 411, are provided so as to face the disc 104.

On the other hand, two disc-side terminals 46a and 46b, which are two concentric ringlike conductive regions, are provided around the outer periphery of the planar loudspeaker 40 on the label side 100B of the disc 104. While the disc 104 is being stored in the disc cartridge 304, the body-side terminals 416a and 416b contact with the disc-side terminals 46a and 46b, respectively. Each of the disc-side terminals 46a and 46b may be divided into a plurality of arcs with a gap, which is shorter than the length of the body-side terminals 416a and 416b as measured in the tangential direction of the disc, provided between them.

The stopper portion 415 of this preferred embodiment is supported so as to be rotatable around the fulcrum 415a and elastic force is applied from a torsion spring, for example, to the stopper portion 415 toward the disc 104. Accordingly, while the shutters (not shown) are closed and the disc is held by the disc holding portions, the body-side terminals 416a and 416b contact with the disc-side terminals 46a and 46b, respectively. On the other hand, when the shutters are opened, the stopper portion 415 is raised by the convex portions of the shutters against the elastic force applied. As a result, the body-side terminals 416a and 416b separate themselves from the disc-side terminals 46a and 46b.

The planar loudspeaker 40 as the first functional portion cooperates with the second functional portion to achieve audiovisual effects. Specifically, if the user turns the switch 417 while the disc cartridge 304 including the disc 104 is not loaded in a disc drive, the disc cartridge 303 enters a recording mode. In the recording mode, sound can be recorded with the microphone 413. The recorded sound is converted by the control section 411 into audio information, which is then stored in the memory 412. On the other hand, if the disc cartridge 304 is made to enter a reproducing mode by turning the switch 417, then the audio information stored in the memory 412 is converted by the control section 411 into an audio signal, which is then reproduced through the loudspeaker. The audio information to be reproduced may either have been recorded with the disc cartridge 304 or be related to the contents of the disc 103 (e.g., musical tunes or video stored on the data storage layer of the disc 103).

The disc-side terminals 46a and 46b of the disc 104 are provided as rings on the label side 100B of the disc 104. Accordingly, no matter at what rotational angular position the disc 104 is stored in the disc cartridge 304, the body-side terminals 416a and 416b can always contact with the disc-side terminals 46a and 46b and sound is always ready to be reproduced or recorded.

On the other hand, when the disc cartridge 303 including the disc 104 is loaded into a disc drive, the shutters of the disc cartridge 303 are opened and the disc holding portions release the disc 104. At this time, the stopper portion 415 is lifted and the body-side terminals 416a and 416b separate themselves from the disc-side terminals 46a and 46b. Accordingly, while read and/or write operation is being carried out on the disc 104, the rotation of the disc 104 is not interfered with by the contact of the body-side terminals 416a and 416b with the disc-side terminals 46a and 46b.

In this manner, according to this preferred embodiment, sound can be reproduced through the planar loudspeaker on the label side of the disc by using the loudspeaker and the memory (in which audio information is stored) and the control section in the disc cartridge. That is to say, the disc cartridge 304 including the disc 104 can be a more attractive product by increasing the audiovisual effects of the disc cartridge 304. In particular, if sound that is related to the musical tunes or movie on the disc 103 is stored in the memory, then a part of the contents can be listened to even without using a disc drive. As a result, the contents of the disc 104 can be presented even more effectively and attractively enough for customers.

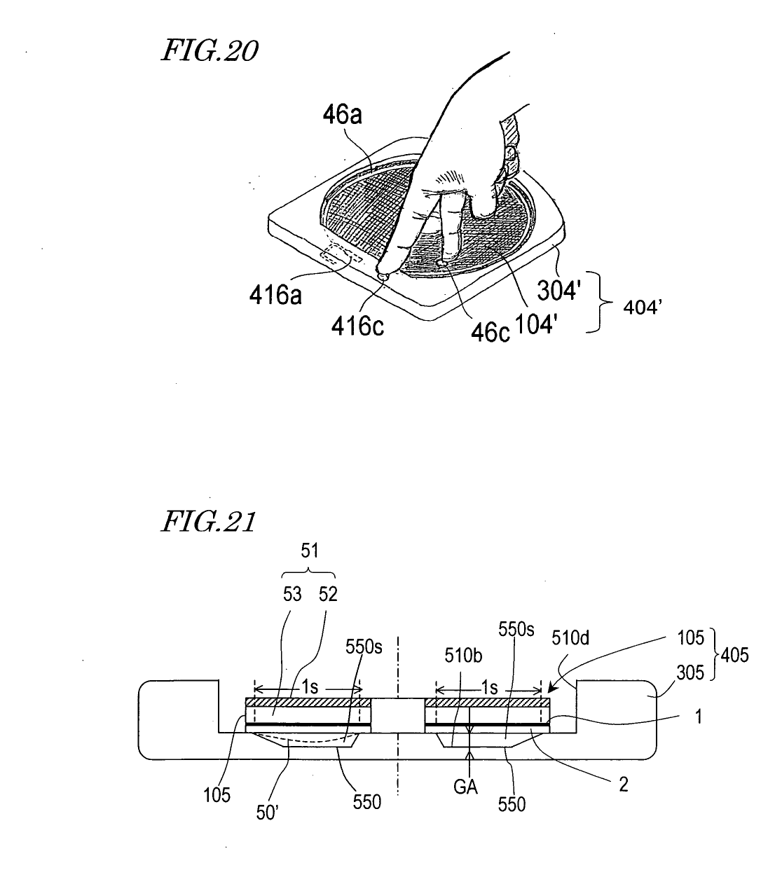

In the preferred embodiment described above, the sound reproduction is controlled by using the switch. However, the switch may be replaced with any other means. For example, a data storage medium 404 including a disc 104′ and a disc cartridge 304′ such as that shown in FIG. 20 includes a disc-side terminal 46c with an electrically conductive land-like surface on the label side 100B of the disc 104′ in place of the ringlike disc-side terminal 46b and a body-side terminal 416c with an electrically conductive land-like surface on the upper surface of the cartridge body in place of the body-side terminal 416b, respectively. To reproduce the audio information that is stored in the memory 414, the user touches the disc-side and body-side terminals 46c and 416c with his or her fingers at the same time. Then, current flows between these terminals and the sound can be reproduced. By using such a structure, the switch can be omitted.

### Embodiment 5

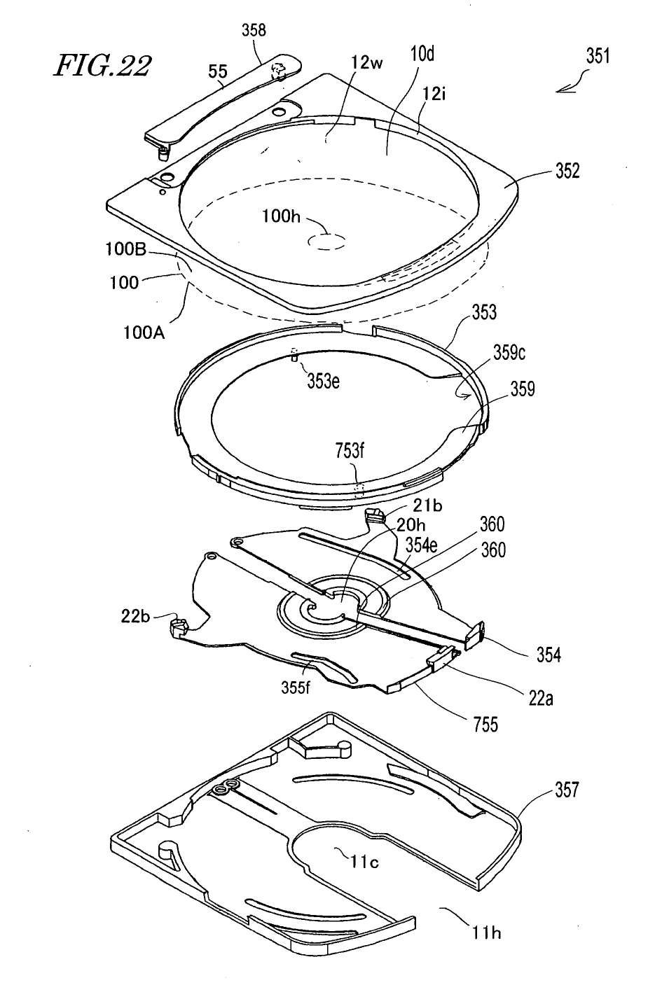

Hereinafter, a disc cartridge according to a fifth embodiment of the present invention will be described. FIG. 21 is a cross-sectional view illustrating a data storage medium 405 including a disc 105 and a disc cartridge 305 to store the disc 105 therein.

The disc cartridge 305 has the same structure as the disc cartridge 301 that has already been described with reference to FIGS. 1 through 10. The disc cartridge 305 stores the disc 105 therein such that the label side 100B of the disc 105 is fully exposed through the disc window 12w of the disc cartridge 305.

As shown in FIG. 21, the disc 105 includes a data storage layer 1, a first substrate 51 and a second substrate 2. The data storage layer 1 is sandwiched between the first and second substrates 51 and 2. The second substrate 2 serves as the data recording side 100A, while the first substrate 51 serves as the label side 100B.

The first substrate 51 includes a substrate layer 53 functioning as a carrier to support the data storage layer 1 thereon and a pressure-sensitive layer 52 provided on the surface of the substrate layer 53. When pressure is applied onto the surface of the pressure-sensitive layer 52 (i.e., onto the label side 100B), the pressure-sensitive layer 52 changes its color. Optionally, a pressure-sensitive layer 52, of which the color density changes with the pressure, may be used. The pressure-sensitive layer 52 serves as the first functional portion. The pressure-sensitive layer 52 does not have to cover the substrate layer 53 entirely but may be divided into multiple regions that are arranged at regular intervals, for example.

On the other hand, the disc cartridge 305 has a recess 550 on the bottom of the disc storage portion such that a space 550S is present under the data recording area 1S of the data recording side 100A when the disc 105 is stored in the disc cartridge 305. The recess 550 may be provided for the shutters 21 and 22 of the disc cartridge 301 that has already been described with reference to FIGS. 1 through 10. The recess 550 has a depth GA and serves as the second functional portion.

When the user presses the disc 105 on the label side 100B thereof, the disc 105 is flexed. As shown in FIG. 21, if the amount of flexure reaches approximately 80% of GA, for example, as indicated by the dashed curve 50′, then the pressure-sensitive layer changes its color to show an alert that the disc 105 might get scratched due to contact of the data recording side 100A with the bottom of the recess 550.

In the preferred embodiments described above, the disc cartridges have the structure shown in FIGS. 1 through 10 in common. However, the disc cartridge may also have any other structure as long as the disc cartridge can store a disc therein with the label side thereof exposed. For example, according to the present invention, the structure of the disc cartridge 351 shown in FIG. 21 may be adopted. As shown in FIG. 21, the disc cartridge 351 includes a cartridge upper shell 352, a cartridge lower shell 357, a rotational member 353, shutters 354 and 355, and a stopper portion 358. The cartridge upper and lower shells 352 and 357 include a disc storage portion 10d with a disc window 12w just like the disc cartridge 301.

The shutters 354 and 355 are provided on the bottom of the disc storage portion 10d so as to expose or cover the head opening 11h.

The rotational member 353 is held over the shutters 354 and 355 in the disc storage portion 10d, and includes protrusions 353e and 353f. Also, the shutters 354 and 355 are provided with grooves 354e and 355f that engage with the protrusions 353e and 353f, respectively. Accordingly, by rotating the rotational member 353, the shutters 354 and 355 can be opened and closed.

The rotational member 353 includes a disc receiving portion 359, which contacts with the outer periphery of the data side 100A of the disc 100 and receives the data 100 thereon when the shutters 354 and 355 are closed, and a notch 359c, which is provided for the disc receiving portion so as to be located inside of the head opening when the shutters are opened.

The disc storage portion 10d includes a sidewall 12i around the outer periphery of the bottom. The disc holding portions 21b, 22a and 22b of the shutters 354 and 355 hold the disc 100 thereon with the center of the disc 100 offset from that of the disc storage portion 10d such that the outer side surface of the disc 100 contacts with the sidewall 12i of the disc storage portion 10d in the region where the notch 359c of the rotational member 353 is present while the shutters are closed. Also, while the disc 100 is being held by the disc holding portions 21b, 22a and 22b, the outer periphery of the data recording side 100A of the disc contacts with the disc receiving portion 359.

The shutters 354 and 355 are provided with a hole 20h corresponding to the center hole of the disc 100. Also, protrusions are provided so as to surround the hole 20h. While the shutters are closed and the disc 100 is held by the disc holding portions 21b, 22a and 22b, the data recording side of the disc 100 contacts with the disc receiving portion 359 and the protrusions 360. Also, as described above, where the disc receiving portion 359 is not present, the disc contacts with the sidewall 121. Accordingly, a closed space is formed under the data recording area of the disc 100. By providing this space, no dust will be deposited on the data recording area and the data recording area will not get scratched due to contact with the disc cartridge.

### INDUSTRIAL APPLICABILITY

According to the present invention, a disc and a disc cartridge, which achieve novel and excellent audiovisual effects that have never been accomplished by any conventional disc or disc cartridge and which are very attractive for buyers, are realized. In addition, a disc drive is also provided for such a disc or disc cartridge.

1. A disc cartridge for storing a disc that has a first side with a first functional portion and a second side, the disc cartridge comprising:
a cartridge body including a disc storage portion, a chucking opening and a head opening, wherein the disc storage portion has a disc window and a bottom and stores the disc therein so that the first side thereof is exposed through the disc window; the chucking opening is provided on the bottom of the disc storage portion so as to get the disc chucked externally; and the head opening is also provided on the bottom of the disc storage portion so as to allow a head, which reads and/or writes data from/on the second side of the disc, to access the second side of the disc;
a shutter, which is supported to, and movable with respect to, the cartridge body so as to expose or cover at least the head opening; and
a second functional portion, which is provided for the cartridge body and which produces an audiovisual effect by cooperating with the first functional portion of the disc.

2. The disc cartridge of claim 1, wherein the first and second functional portions produce a visual effect by cooperating with each other.

3. The disc cartridge of claim 1, wherein the first and second functional portions produce an audio effect by cooperating with each other.

4. The disc cartridge of claim 1, wherein audiovisual information is stored on the second side of the disc, and the audiovisual effect is associated with the audiovisual information on the second side of the disc.

5. The disc cartridge of claim 2, wherein the first functional portion is a first design provided on the first side, the second functional portion is a second design provided on a portion of the upper surface of the cartridge body near the disc window, and the first and second designs are combined together to make up a third design that looks like a single continuous design.

6. The disc cartridge of claim 5, wherein the first design is a picture drawn on the first side and the second design is a picture drawn on the upper surface.

7. The disc cartridge of claim 6, wherein the first and second designs are planar.

8. The disc cartridge of claim 6, wherein the first and second designs are embossed.

9. The disc cartridge of claim 8, wherein the depth of the first embossed design is substantially equal to that of the second embossed design.

10. The disc cartridge of claim 6, wherein the first side of the disc and the upper surface of the cartridge body are textured.

11. The disc cartridge of claim 6, wherein the first and second designs are holograms.

12. The disc cartridge of claim 2, wherein the first functional portion is a tablet that is provided on the first side to allow the user to draw or erase any traces thereon or therefrom, and the second functional portion is an erasing portion that is provided for the cartridge body and is used for erasing the traces that have been drawn on the tablet.

13. The disc cartridge of claim 12, wherein the tablet includes a magnetic body so as to allow the user to draw the traces by bringing a magnet or another magnetic body close to the surface of the tablet.

14. The disc cartridge of claim 13, wherein the tablet includes a plurality of small rooms, each being filled with a viscous fluid and a magnetic powder.

15. The disc cartridge of claim 14, wherein the erasing portion is a magnet plate that is provided on the bottom of the disc storage portion of the cartridge body.

16. The disc cartridge of claim 15, wherein the traces that have been drawn on the tablet are erased by rotating the disc within the disc storage portion of the cartridge body.

17. The disc cartridge of claim 2, wherein the first functional portion is a matrix-addressed display device that is provided on the first side and that includes a liquid crystal, organic EL or inorganic EL material, and wherein the second functional portion is provided for the cartridge body and includes a control section for driving the matrix-addressed display device, a memory for storing image data to be presented on the matrix-addressed display device, and a power supply for supplying power to the matrix-addressed display device.

18. The disc cartridge of claim 17, wherein the second functional portion further includes a loudspeaker provided for the cartridge body.

19. The disc cartridge of claim 17, wherein the first functional portion further includes a transparent tablet on the surface of the matrix-addressed display device such that information fed into the tablet is displayed on the matrix-addressed display device.

20. The disc cartridge of claim 3, wherein the first functional portion is a planar loudspeaker that is provided on the first side, and wherein the second functional portion includes a memory for storing audio information to be reproduced through the planar loudspeaker, a control section for converting the audio information and transmitting a signal to the planar loudspeaker, and a power supply for supplying power to the control section.

21. The disc cartridge of claim 18, wherein the second functional portion further includes a microphone that is provided for the cartridge body, and wherein the control section converts sound, recorded with the microphone, into the audio information and then stores the information in the memory.

22. The disc cartridge of one of claim 17, wherein the disc includes a disc-side terminal, which is connected to the first functional portion and which is provided on the outer periphery of the disc, and wherein the cartridge body includes a body-side terminal which is connected to the second functional portion.

23. The disc cartridge of claim 22, wherein the disc cartridge further includes a disc holding portion for holding the disc thereon while the shutter is closed, and wherein the disc-side and body-side terminals are contactable with each other while the disc is being held by the disc holding portion.

24. The disc cartridge of claim 23, wherein the disc-side terminal is a plurality of concentric ringlike conductive regions provided along the outer periphery of the disc.

25. The disc cartridge of claim 23, wherein the disc has a disc-side mark and the cartridge body has a body-side mark, and wherein when the disc is rotated within the disc storage portion of the cartridge body such that the disc-side and body-side marks are aligned with each other, the disc-side and body-side terminals contact with each other.

26. The disc cartridge of claim 17, wherein the disc includes a disc-side terminal, which is connected to the first functional portion, provided on the first side and has a conductive surface, while the cartridge body includes a body-side terminal, which is connected to the second functional portion, provided on the upper surface of the cartridge body and has a conductive surface, and wherein when the disc-side and body-side terminals are touched with fingers at the same time, the first and second functional portions are electrically connected together.

27. A disc drive comprising:
a supporting portion into which the disc cartridge of claim 1 is loadable, a disc having a first side with a first functional portion and a second side being stored in the disc cartridge;
a spindle motor for mounting and rotating the disc thereon;
a head, which is able to read and/or write data from/on the second side of the disc;
a sensor for detecting a rotational angular position of the spindle motor when the disc is mounted on the spindle motor; and
a control section for controlling the spindle motor in accordance with a command to eject the disc cartridge such that the spindle motor stops at the rotational angular position when the disc is mounted thereon.

28. A disc drive comprising:
a supporting portion into which the disc cartridge of one of claims 1 to 16 claim 1 is loadable, a disc having a first side with a first functional portion and a second side being stored in the disc cartridge;
a spindle motor for mounting and rotating the disc thereon;
a head, which is able to read and/or write data from/on the second side of the disc;
a sensor for detecting a mark on the second side of the disc; and
a control section for controlling the spindle motor such that the spindle motor stops at a position where the mark of the disc is detected.
